(19) United States
(12) Patent Application Publication
(10) Pub. No.: US 2011/0283173 A1
(43) Pub. Date: Nov. 17, 2011

(54) METHODS AND SYSTEMS FOR DESIGNING PHOTO BOOKS

(75) Inventors: Sally Babcock, Rocky River, OH (US); Chris Braunsdorf, Shaker Heights, OH (US); Karen Couchey, Wadsworth, OH (US); Hugh Graham, Denver, CO (US); Patrick Hansen, Denver, CO (US); Joseph Joyce, Fairview Park, OH (US); Philip Perone, Shaker Heights, OH (US); Mark Smith, Denver, CO (US); Matthew Stein, Copley, OH (US); Robert Van Curen, Parma Heights, OH (US); Chuck Williams, Centennial, OH (US); Heather Zhong, Solon, OH (US); Dan Zimmerman, Poulsbo, WA (US)

(73) Assignee: American Greetings Corporation, Cleveland, OH (US)

(21) Appl. No.: 12/969,808

(22) Filed: Dec. 16, 2010

Related U.S. Application Data
(60) Provisional application No. 61/284,379, filed on Dec. 16, 2009.

(51) Int. Cl. G06F 17/20

(52) U.S. Cl. 715/202

(57) ABSTRACT

A method of creating a photo book based on a user-selected, predefined theme is disclosed. During creation of the photo book, design options such as styles, layouts, and design elements are adjusted dynamically based on the selected theme.

### RELATED APPLICATION

The present application is being filed as a U.S. non-provisional patent application claiming priority/benefit under 35 U.S.C. §119(e) from the U.S. provisional patent application having Ser. No. 61/284,379 and filed on Dec. 16, 2009, the entire disclosure of which is incorporated herein by reference.

### FIELD

The invention relates generally to data processing and, more particularly, to methods, systems, and/or devices for the on-line creation of photo books.

### BACKGROUND

The widespread use of digital cameras has resulted in a substantial shift from the creation of film-based images to the creation of digital images by users. As a result, many online photo-sharing sites have been introduced. These photo-sharing sites allow users to upload their digital images to the site for storage. Additionally, these sites typically provide tools for allowing the users to manage and edit their digital images. Furthermore, the users may designate other authorized users to have access to some or all of their digital images. Further still, the site may offer tools that allow the users to design and purchase products incorporating their digital images.

One such photo-sharing site is the PHOTOWORKS site owned by AG Interactive, Inc., a subsidiary of American Greetings Corporation, and accessible at www.photoworks.com. After a user creates an account by accessing the PHOTOWORKS site, the user can log into the site and upload digital images thereto, as well as using various tools to manage, edit, and share the digital images. Additionally, the user can access the site to create products incorporating selected digital images. Examples of products that can be designed and purchased through the site include jewelry, apparel, calendars, cards, mouse pads, mugs, and stationery. A photo book is another product that can be produced through the site.

A “photo book” is a collection of photos, text, and design elements (e.g., graphic art) that form a book of pages between a front cover and a back cover. The photos are often selected based on their relationship to a chosen theme for the photo book. Exemplary themes include anniversary, baby, back to school, birthday, congratulations, family, graduation, holidays, kids, love, pets, reunions, sports, travel, or wedding. A photo book may require a predefined number or range of pages. The photo book may also require a predefined number or range of photos for inclusion therein. The photo book may have a soft cover or a hard cover. Photo books can come in different sizes and shapes.

By using various design tools made available through the site, a user can create a photo book with his or her selected digital images and chosen design elements. Once the user is satisfied with the design of the photo book, the user can place an order for the photo book, including paying for the photo book, through the site. Thereafter, the completed photo book with the selected digital images printed therein is delivered or otherwise made available to the user. Likewise, the photo book design could be stored for sharing with others.

The process of designing a photo book often involves the user making various changes (e.g., selection and placement of digital images, design elements, backgrounds, and text) to a page and then observing how those changes impact the appearance of the page and the overall impression of the photo book. This trial and error approach means that the process of designing the photo book may span several hours and even several sessions at the site. Additionally, the user generally is presented with a large number of design options for increased flexibility in designing the photo book. For example, the user is able to select the digital images, design elements, and backgrounds for inclusion on the pages and covers of the photo book, the theme for the photo book, the layout or style for each of the pages, and the text to be used in the photo book, as well as the font, size, and color for the text. Unfortunately, the increased flexibility that comes with unfettered access to a large number of design options gives rise to a potential increase in the tediousness of the aforementioned trial and error approach. Because it can take even longer to consider all of the possible design combinations, with many of the design choices leading to aesthetically unappealing results, the user may become frustrated with the process and simply abandon creation of the photo book.

Accordingly, there is a need in the art that for a process of designing a product, such as a photo book, that dynamically and intelligently adjusts the design options currently available to the user based on previous design selections by the user. Thus, the user is only presented with those design options that are logically and/or aesthetically appropriate given the current state of the user's prior selections. In this manner, overall convenience of the design process is enhanced, with the process remaining sufficiently flexible to accommodate the creative input of the user.

### SUMMARY

In view of the above, it is an exemplary aspect to provide methods and systems for the dynamic, intelligent creation of photo books.

It is another exemplary aspect to provide methods and systems for creating photo books which effectively balance convenience and flexibility in the design process.

It is still another exemplary aspect to provide methods and systems for creating photo books which prevent users from choosing combinations of design options that do not conform to a selected theme, layout, design element, or the like.

Numerous other aspects, advantages and/or features of the general inventive concepts will become more readily apparent from the following detailed description of exemplary embodiments, from the current and/or eventual claims, and from the accompanying drawings and related papers being submitted herewith.

### DESCRIPTION OF DRAWINGS

In addition to being illustrated by the various papers being submitted herewith, the general inventive concepts as well as embodiments and advantages thereof are described below in greater detail, by way of example, with reference to the drawings in which:

FIG. 1 is a flowchart illustrating a method of creating a photo book, according to one exemplary embodiment.

FIG. 2. is a screenshot of a user interface, according to one exemplary embodiment, for use in creating a photo book.

FIG. 3 is a diagram of a system for creating a photo book, according to one exemplary embodiment.

FIG. 4 is a diagram of logic flow, according to one exemplary embodiment, of a system for creating a photo book.

### DESCRIPTION

While the general inventive concepts are susceptible of embodiment in many different forms, there are shown in the drawings and will be described herein in detail specific embodiments thereof with the understanding that the present disclosure is to be considered as an exemplification of the principles of the general inventive concepts. Accordingly, the general inventive concepts are not intended to be limited to the specific embodiments illustrated herein. Additionally, the following definitions are provided to facilitate description of the various exemplary embodiments presented herein.

The term “project” means a current photo book being designed by a user. A user may be working on one or more projects at any given time. Each project will have its own asset library, as well as associated pages, covers, styles, layouts, and design elements.

The term “page” means any of the pages of a project. The term “page” can include the front and/or back covers (as well as possibly the side binding) of a project. The term “spread” refers to a pair of adjacent pages of the project. Not every page (e.g., the covers) is part of a spread, but every spread includes two pages.

The term “theme” means a collection of recommended styles related to a particular event or milestone. For example, a “travel” theme will offer several different styles, some of which could be specifically developed (e.g., “beach”) and some of which could be generic (e.g., “basic black”).

The term “style” refers to a template or building block on which each page is created. Each style includes a number of style elements that are customized for its particular presentation. These style elements can include, for example, one or more backgrounds, font information, and photo borders.

The term “global style” refers to a style that is applied to all the pages of a project. For example, at the onset of a new project, a user can select the global style for the project or a default global style may automatically be selected by the system. Thereafter, the user can change the global style and/or override the style settings on any of the pages.

The term “layout” refers to the organization of photos, text, and/or design elements on a page. A layout serves as the structure (e.g., template) for adding content to a page. A layout can be fixed or dynamically adjustable.

The term “asset library” means a collection of content created, selected, or otherwise identified by a user for use in a project. The content can include digital images (e.g., from one or more of the user's online albums), as well as theme-specific design elements, for example, provided by a photo-sharing site or other content provider.

The term “design elements” refers to content such as graphic art, which is typically predefined, that a user can use to add additional components to pages within a project. The design elements can be organized, for example, by theme (e.g., travel, birthday, pets).

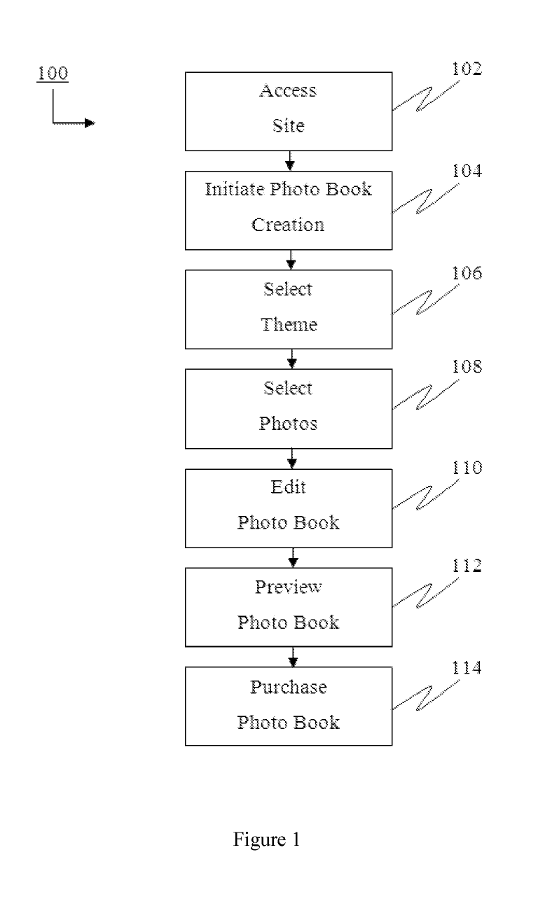

A method 100 for creating a photo book, according to one exemplary embodiment, will be described with reference to the flow chart of FIG. 1. The method 100 begins with a user accessing the photo-sharing site (e.g., www.photoworks.com) or other photo book generation system, as indicated by step 102 in FIG. 1. If the user already has an account with the site, the user is prompted to enter his or her user name and password so that the site can authenticate the user. Otherwise, the user is prompted to register with the site in order to receive a user name and password for accessing the site. One of ordinary skill in the art will appreciate that a method of user authentication other than password verification could be used.

Once logged into the site, the user initiates creation of a photo book, as indicated by step 104 in FIG. 1. For example, the user can select a “photo books” link or image within a “products” menu or section of the site to start a project for the photo book. Each user can have many projects. Accordingly, the user may be prompted to name the newly created project. Alternatively, the system could automatically assign the project a name. In one exemplary embodiment, the user can grant other users access to the project, allowing for collaborative creation of a photo book.

In step 106, the user selects a theme for the project. Because users are often inspired to create a photo book based on some sort of event or milestone, themes are typically modeled after such events and milestones. Exemplary themes include anniversary, baby, birthday, classics, family reunion, graduation, memorial, party, pets, relationships, travel, and wedding. In step 106, the user can browse a set of predefined themes to find and select a desired theme.

Each theme is associated with its own collection of recommended styles. As noted above, a style is a template or building block on which each page of a project is created. Each style includes a number of style elements that are customized for its particular presentation. These style elements can include, for example, one or more backgrounds, font information, and photo borders. The same style may be associated with different themes.

Which theme the user selects directly impacts which styles are subsequently made available to the user. A sufficient number of different styles are made available for each theme so that the user retains the ability to personalize the photo book with his or her own creative vision. However, by excluding those styles that simply are not a “good fit” for the selected theme, the user is prevented from wasting time considering poor style choices.

The general inventive concepts contemplate that any criteria could be used in determining which styles should be associated with which themes. In one exemplary embodiment, design professionals, administrative personnel associated with the photo-sharing site, or other individuals could vet the various theme and style combinations to determine which styles should be associated with which themes. In another exemplary embodiment, a computer could be used to statistically model user theme and style preferences during a series of mock photo book creation simulations involving randomly selected users.

In one exemplary embodiment, the user can readily customize or otherwise modify various components of the available styles (e.g., font size, photo borders on or off). However, the options presented to the user for modifying the styles have been carefully pre-selected based on their potential impact on the overall design of the photo book. As a result, the user is only presented with quality choices as opposed to a long list of possible style component alternatives.

Additionally, to further increase the design flexibility of the method 100, each style can include many layouts. As noted above, a layout is how photos, text, and/or design elements are organized on a page. As noted above, the layouts can be fixed or dynamically adjustable. Exemplary layouts for a page include text only with no photo (title page), text and one vertical photo, text and one horizontal photo, text and two vertical photos, two horizontal photos with no text, one vertical photo and one horizontal photo with no text, and two vertical photos and one horizontal photo with no text. In general, layout possibilities are only constrained by a maximum number of photos and amount of text that can be accommodated on a page. The same layout may be available in different styles. Some layouts may be limited to a particular use, for example, the covers.

A sufficient number of different layouts are made available for each style so that the user retains the ability to personalize the photo book with his or her own creative vision. However, by excluding those layouts that simply are not a “good fit” for the selected style, the user is prevented from wasting time considering poor layout choices. In one exemplary embodiment, each style is associated with 2 or more different layouts. Furthermore, the number of layouts available for a particular style may be dynamically adjusted based on other user actions, selections, or the like within a project.

The general inventive concepts contemplate that any criteria could be used in determining which layouts should be associated with which styles. In one exemplary embodiment, design professionals, administrative personnel associated with the photo-sharing site, or other individuals could vet the various theme, style, and layout combinations to determine which layouts should be associated with which styles. In another exemplary embodiment, a computer could be used to statistically model user theme, style, and layout preferences during a series of mock photo book creation simulations involving randomly selected users.

In one exemplary embodiment, the user can readily customize or otherwise modify the available layouts. However, the options presented to the user for modifying the layouts have been carefully pre-selected based on their potential impact on the overall design of the photo book. As a result, the user is only presented with quality choices as opposed to a long list of possible layout alternatives.

Once a theme is selected by the user, the user is then prompted to input photos (e.g., in the form of digital images) for the project in step 108. In one exemplary embodiment, digital images on the photo-sharing site are stored in albums which are used to organize or otherwise group the digital images. Thus, the user can be prompted to identify an album containing digital images to be used for the project. In one exemplary embodiment, the user can create or otherwise define a collection of digital images to use for the project, as opposed to dealing with discrete albums.

In one exemplary embodiment, a project may require a minimum number of digital photos be used to complete the project, although the same digital photo may be used more than once to satisfy this requirement.

In one exemplary embodiment, the user can see which photos are used on which pages and can use this information to navigate directly to a desired page. In one exemplary embodiment, the user can elect to have those photos which are currently being used hidden (e.g., not displayed) or grayed out.

If no albums or digital images are detected by the system, the user is alerted to this and prompted to upload digital images to the photo-sharing site. In one exemplary embodiment, the digital images are stored on and uploaded from the user's computer. In another exemplary embodiment, the digital images are stored on and uploaded from another location (e.g., a third party photo-sharing site) identified by the user.

In one exemplary embodiment, the system compares a number of digital images provided by the user against a number of photo locations, bins, or the like that can be accommodated by the selected theme (and its default styles and layouts). A photo location is an area on a page designated for receiving or otherwise accommodating a digital image. If the number of digital images is greater than the number of photo locations, the user is notified how many digital images will not be able to be used in the project. If the number of digital images is less than the number of photo locations, the user is notified how many photo locations will remain empty in the project. The user will be able to make further edits later, including providing additional digital images and/or pages if desired. If the number of digital images is equal to the number of photo locations, the user is notified that all of the digital images can be used in the project.

In one exemplary embodiment, the system will automatically associate each digital image with a corresponding photo location until either all of the digital images have been associated with a corresponding photo location or all of the photo locations have been associated with a corresponding digital image. This auto-filling operation can speed up creation of the photo book, as the user no longer needs to associate a digital image with each photo location. Instead, the user can now proceed to editing the project, such as rearranging the digital images among the photo locations as desired.

In one exemplary embodiment, the user can set various options for the auto-filling operation, such as an indicating an order for placement of the digital images in the photo book or specifying which photos should go together on the same page.

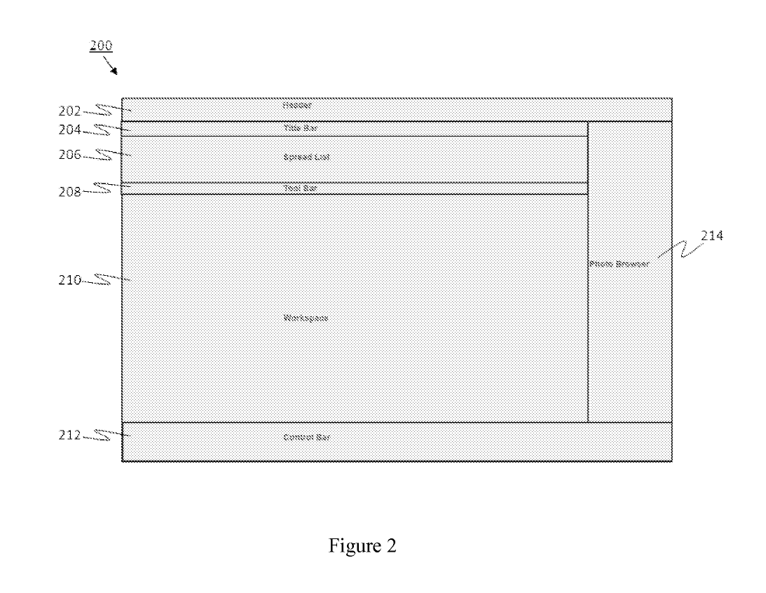

After an album of digital images has been input or otherwise designated for the project, editing of the photo book commences in step 110. In one exemplary embodiment, the editing phase includes launching a user interface, such as the user interface 200 shown in FIG. 2 and described below. The user interface facilitates creation and editing of the photo book. During the editing phase, the user can modify various aspects of the photo book of the current project. Generally, editing of the photo book occurs on a page-by-page basis.

In one exemplary embodiment, different views are available during the editing phase. For example, the user can select from among a single page view, a spread view, and a storyboard view. Any of these views could be set as the default view.

In the single page and spread views, a menu or other listing of thumbnails is available, wherein the thumbnails correspond to the pages and/or spreads of the project. In one exemplary embodiment, a larger view of a thumbnail is presented to the user upon selection of the thumbnail (e.g., by clicking on or rolling over the thumbnail).

In the single page view, the user is presented with a close up of a single page of the project. In the single page view, the adjacent page is shaded to provide context of the location of the current page being edited (e.g., whether it is a right or left page). The user can change the displayed single page by selecting a different page using the thumbnails.

In the spread view, the user is presented with a spread of the project. In this view, a close up of two pages (left and right) corresponding to a currently selected thumbnail is displayed. Only one of the two pages, however, can be selected (and edited) at a time. The selected page can be designated in any manner, for example, by a surrounding border. The user can change the displayed spread by selecting a different spread using the thumbnails.

In the storyboard view, the user is presented with the whole photo book presented as a front cover, a series of spreads, and a back cover. The aforementioned thumbnails are not visible in this view, which allows more of the screen to be dedicated to presenting the photo book. This view allows the user to see all or a large portion of the photo book at once. Since the whole photo book typically cannot be displayed on the screen at once, a scroll bar may be provided as known in the art. In this view, some edits can be made directly to the pages displayed on the screen. In one exemplary embodiment, photos could be added to and/or moved between pages directly from the storyboard view.

In one exemplary embodiment, interaction in one view may cause a transition to a different view. For example, double clicking on one of the thumbnails in the storyboard view could take you to a spread view corresponding to the page of the clicked thumbnail.

During the editing phase of step 110, the user can perform various actions related to the project. For example, the user can title the photo book, rearrange pages within the photo book, add pages to the photo book, and remove pages from the photo book. Additionally, the user can input text at a text location on a page and drag-and-drop a digital image into a photo location on a page.

To further increase the design flexibility of the method 100, the user is presented with many design elements that can also be added to the pages. As noted above, design elements are additional content, such as graphic art, that can be used to further accentuate a photo book. The design elements can be organized, for example, by theme (e.g., travel, birthday, pets). In this manner, the design elements can be associated with one or more themes and the corresponding styles, such that which theme the user selects directly impacts which design elements are subsequently made available to the user.

A sufficient number of different design elements are made available for each theme so that the user retains the ability to personalize the photo book with his or her own creative vision. However, by excluding those design elements that simply are not a “good fit” for the selected theme, the user is prevented from wasting time considering poor design choices. For example, an image of a pacifier, as a design element, may be appropriate for the “baby” theme but not the “anniversary” theme.

The general inventive concepts contemplate that any criteria could be used in determining which design elements should be associated with which themes. In one exemplary embodiment, design professionals, administrative personnel associated with the photo-sharing site, or other individuals could vet the various theme and design element combinations to determine which design elements should be associated with which themes. In another exemplary embodiment, a computer could be used to statistically model user theme and design element preferences during a series of mock photo book creation simulations involving randomly selected users.

Additionally, design constraints can be defined to work in both directions. In one exemplary embodiment, selection of a particular design element (available for a selected theme and style) by the user may result in the dynamic adjustment of what style component options are available to the user. For example, if the aforementioned pacifier design element is selected by the user, the user may then be prevented from changing the background color of an available style to green, as this background color and design element combination has been predefined as a poor design combination. As another example, certain design element and font combinations can be predefined as poor design choices and, thus, not made available to the user. In this manner, the user is only presented with quality choices as opposed to a long list of alternatives, with the list of available design choices at any given time being dynamically adjusted based on the user's prior design selections.

In one exemplary embodiment, each design element is intended to fit with an available layout chosen by the user. If the user selects another available layout, then the design element is dynamically adjusted. For example, if the user switches from a layout with a single photo location to a layout with several photo locations, the design element is automatically repositioned on the page to accommodate this new layout.

In one exemplary embodiment, the user is able to quickly cycle through the available design options for a project, which promotes a more interactive experience with the user.

In one exemplary embodiment, a design element includes associated information that the user can customize. For example, a design element might be a graphic including the numeral 40 therein. If the user elects to edit this information, such as by inputting the numeral 50, the design element is dynamically updated to reflect this updated information. In this manner, flexibility of the design process is further enhanced by allowing the user to create more personalized variations of provided design elements.

In one exemplary embodiment, the user's current design selections result in dynamic adjustment of previously applied design elements. As a result, one or more attributes of a design element placed on a page of the project are automatically modified based on subsequent design selections by the user. For example, if the user elects to change the current layout, an attribute such as a color, size, position, etc. of the design element is modified accordingly based on predetermined associations between each layout and the design element. In this manner, the user is prevented from having to manually adjust each design element to see how different design selections (e.g., layouts) look. Accordingly, the user can easily step or cycle through a series of available layouts to see how any applied design elements appear therein. Additionally, the dynamic adjustment of the design elements further prevents the user from introducing a poor design choice into the project. In one exemplary embodiment, the user can be alerted that the previously selected design element is not appropriate or no longer available given the user's current design selections.

During the editing phase of step 110, the user can add available design elements at design element locations on a page. The design element locations may or may not be the same as the photo locations. Furthermore, permissible style (e.g., background, font) and layout changes may be made during the editing phase.

In one exemplary embodiment, various design choices such as formatting options, backgrounds, and design elements can be propagated throughout an entire project. For example, if the user selects a particular font for a text box, the user can assign that font to all similar text boxes in the project.

The user can manually save changes to the project made during the editing phase. In one exemplary embodiment, the system automatically saves the project periodically and/or in response to a predefined event.

The user can elect to preview the project, in step 112, at any time. During this preview phase, the user will see the photo book as it will actually be printed. Indications of text locations, photo locations, and design element locations will be removed. Empty text locations, photo locations, and design element locations will be highlighted (e.g., with warning icons) but may not print. Other information and/or alerts may be provided during the preview phase, such as an indication that a digital image of the project is below an acceptable resolution. In one exemplary embodiment, a table is generated during the preview phase, wherein the table lists all of the warnings. The user can select any of the warnings from the table to navigate directly to the page associated with the warning.

In one exemplary embodiment, the preview phase includes displaying the photo book on the full screen of a display (e.g., monitor).

In one exemplary embodiment, the preview phase supports printing of a proof of the photo book or specified pages therein. The proof may facilitate review of the photo book. In one exemplary embodiment, the proof is printed at a lower resolution than the actual photo book would be printed. In one exemplary embodiment, the proof is printed without color.

In one exemplary embodiment, the preview phase is dynamic and the user can simulate turning the pages of the previewed photo book, for example, by clicking in a designated area on a displayed page (e.g., a curled portion of the displayed page).

From the preview phase, the user can return to the editing phase of step 110, for example, if the user wishes to make additional changes to the project. Additionally, from the preview phase, the user can elect to add the project to a digital shopping cart.

Once a project is added to the shopping cart, the user can elect to purchase the photo book corresponding to the project in step 114. In one exemplary embodiment, the preview phase is a prerequisite to purchasing a photo book. During this purchase phase, the user consents to having the photo book printed in accordance with the project in the shopping cart. This agreement between the user and the service provider (e.g., the photo-sharing site) insures that the user receives a photo book that is printed appropriately and to his or her expectations. In one exemplary embodiment, the purchase phase is handled by another site, i.e., external to the photo-sharing site.

A user interface 200 for facilitating creation of a photo book, according to one exemplary embodiment, is shown in FIG. 2. The user interface 200 is displayed on a client computer of the user. In one exemplary embodiment, the user interface 200 is displayed by a Web browser application running on the client computer.

The user interface includes a header portion 202, a title bar 204, a thumbnail menu 206, a tool bar 208, a workspace 210, a control bar 212, and a photo browser 214. In one exemplary embodiment, the user interface 200 and/or portions thereof may be resizable so that a user can adjust one or more dimensions of the displayed interface.

The header portion 202 contains site-specific branding elements, navigation elements, and other tools, menus, and utilities.

The title bar 204 displays the title of the photo book of the current project, if the photo book has been titled. The title bar 204 also includes a button or other device for accessing a “name your book” functionality.

The thumbnail menu 206 is a horizontal list in which reduced-size images (i.e., thumbnails) of the pages and/or spreads of the photo book of the current project are displayed. A scroll bar is provided for scrolling through the thumbnails within the horizontal list.

The tool bar 208 includes many tools, menus, and utilities useful for the editing and design of the photo book of the current project. For example, the tool bar 208 provides the user with save, preview, and undo/redo controls, as well as add/remove pages controls.

The workspace 210 representing the main area of the user interface 200 in which editing of the photo book of the current project occurs. The workspace 210 contains the actual photo book view (e.g., page display), as well as page information and pagination controls.

The control bar 212 represents the primary collection of interaction controls for the creation and design of the photo book of the current project. The control bar 212 includes tools, menus, and utilities relating to controlling (e.g., selecting, adjusting, browsing, trying) styles, layouts, design elements, backgrounds, and views. Additionally, the control bar 212 includes controls for buying the photo book of the current project.

The photo browser 214 includes a vertical list that includes reduced-size images (i.e., thumbnails) of photos (i.e., digital images) available for use in the current project. A scroll bar is provided for scrolling through the thumbnails within the vertical list. The photo browser 214 is situated, for example, adjacent to the workspace 210.

The photo browser 214 also includes functionality that allows the user to select or otherwise specify an album from which to populate the list of thumbnails. The photo browser 214 also includes functionality that allows the user to upload or otherwise input additional photos. Additional functionality may also be provided by the photo browser 214, such as the ability to magnify a viewing size of a specified thumbnail.

Each thumbnail is a representation of a corresponding photo. The file name of the digital image for a thumbnail is displayed underneath the thumbnail. The user can drag and drop a thumbnail from the photo browser 214 to the workspace 210, thereby associating the corresponding photo to the specified portion of the photo book of the current project.

With the user interface 200, many of the tools and utilities needed during the creation and design of a photo book are readily accessible and intuitively comprehensible to the user. In one exemplary embodiment, the user interface 200 includes photo editing tools (e.g., crop) and effects (e.g., sepia). In one exemplary embodiment, a spell checking tool is provided for checking the spelling and/or grammar of text added to the project. In one exemplary embodiment, the user interface 200 includes a zoom function that allows the user to zoom in and zoom out of portions of the user interface 200. The user interface 200 can also include functionality for providing the user with robust, interactive, contextual help during the creation and design of the photo book. One of ordinary skill in the art will appreciate that the appearance and the functionality of the user interface can be readily modified without departing from the spirit and the scope of the general inventive concepts.

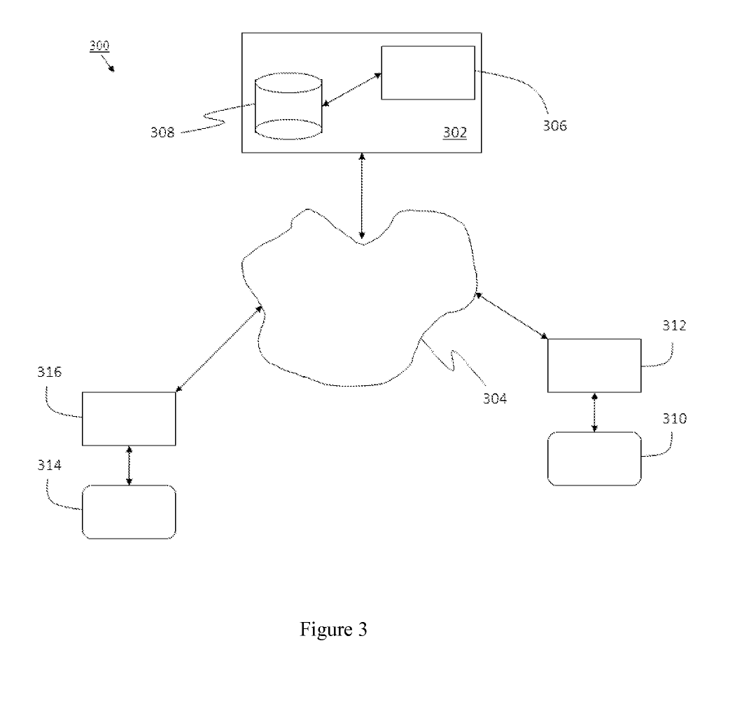

A system 300 for creating a photo book, according to one exemplary embodiment, will be described with reference to the diagram of FIG. 3.

In one exemplary embodiment, the system 300 includes a photo-sharing site 302 that is accessible over a network, such as the Internet 304. The photo-sharing site 302 includes one or more servers 306 and one or more data stores 308, such as a database. The servers 306 and data stores 308 may be centralized or distributed. The servers 306 and data stores 308 interoperate to execute a process for creating a photo book, such as the method 100.

A first user 310 accesses the servers 306 of the photo-sharing site 302 over the Internet 304 using a client computer 312, such as a personal computer, running a Web browser or similar application (not shown). In this manner, the first user 310 can communicate with the photo-sharing site 302 through a series of user interfaces, such as the user interface 200, to effect creation and design of a photo book.

During editing of the photo book, the system 300 dynamically adjusts available design options based on previous design choices made by the user. For example, the system can utilize definitions, rules, mappings, hashes, filters, masks, etc. to determine a current set of valid design options given a set of prior design choices made by the user. In one exemplary embodiment, an XML file is used to manage the various permissible design options. In one exemplary embodiment, a database is used to manage the relationships between the various permissible design options. In this manner, the system 300 maintains a significant degree of flexibility while increasing the overall efficiency and convenience of the photo book creation process by preventing users from making poor design choices.

Once the first user 310 has finished and saved the project corresponding to the photo book, the system 300 can process an order for the finished photo book to be printed and delivered or otherwise made available to the first user 310. Additionally, the first user 310 can make the finished photo book accessible by other users (e.g., friends, family). Accordingly, a second user 314, as authorized by the first user 310, could access the servers 306 of the photo-sharing site 302 over the Internet 304 using a client computer 316, such as a personal computer, running a Web browser or similar application (not shown). The second user 314 is then able to place an order for the photo book if he or she so chooses.

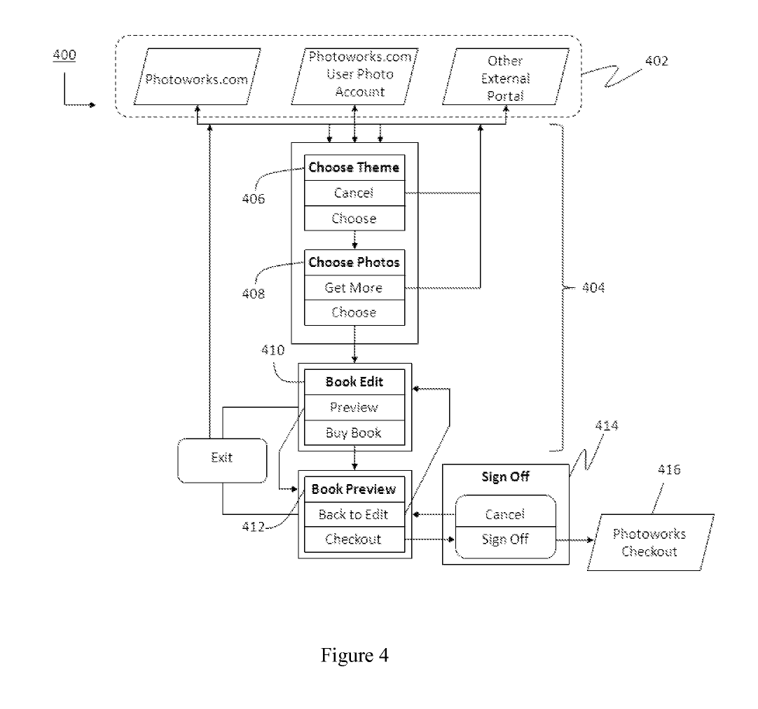

The logic flow 400, according to one exemplary embodiment, of a system for creating a photo book (e.g., the system 300) is shown in FIG. 4.

According to the processes of the exemplary logic flow 400, a user accesses the system through one or more initial access processes 402. For example, the user can access the system via a dedicated web site, a photo account associated with the user on the dedicated web site or another web site, or an external portal, site, or the like.

Thereafter, the logic flow 400 shifts to one or more photo book creation processes 404 including a theme selection process 406. In the theme selection process 406, the user selects a desired theme from among a plurality of available themes. As noted above, the theme has an associated collection of styles and layouts.

The logic flow 400 then shifts to one or more photo selection processes 408. In one exemplary photo selection process, the user is allowed to browse available albums and select an album containing any desired photos. In another exemplary photo selection process, the user could elect to get more photos, in which case additional photo selection processes 408 would be launched to facilitate the user uploading desired photos.

With a desired theme and photos selected, the logic flow 400 shifts to one or more photo book editing processes 410. The photo book editing processes 410 allow the user to create a photo book from scratch using available styles and layouts for the current theme. Alternatively, the photo book editing processes 410 allow the user to edit an existing photo book project.

From the photo book editing processes 410, the user can elect to preview the photo book of the current project or buy the photo book of the current project. If the user chooses to either preview the photo book or buy the photo book, the logic flow 400 shifts to one or more photo book preview processes 412. The photo book preview processes 412 present the photo book of the current project on the screen in a manner that closely approximates the way it will appear if physically printed. Accordingly, the user is able to preview the current state of the photo book anytime during the photo book editing processes 410, as well as when the user elects to purchase the photo book (e.g., by using “add to cart” functionality).

From the photo book preview processes 412, the user can elect to return to editing the photo book, in which case the logic flow 400 will shift back to the photo book editing processes 410. Alternatively, from the photo book preview processes 412, the user can elect to proceed with purchasing the photo book, in which case the logic flow 400 will shift to one or more sign off processes 414.

The sign off processes 414 represent the final step in the photo book creation process. After the user elects to purchase the photo book (e.g., by adding same to their virtual shopping cart), the user is provided with a “sign off” dialog that may include relevant system alerts, messages, and the like. Typically, the “sign off” dialog will include some mechanism (e.g., a check box) by which the user can confirm that they have thoroughly reviewed the photo book and agree to purchasing the same in printed form, after which the user is allowed to elect to proceed to checkout.

The logic flow 400 then shifts to one or more checkout processes 416. In one exemplary embodiment, the checkout processes 416 direct the user to an external site for processing and completion of the photo book purchase.

The above description of specific embodiments has been given by way of example. From the disclosure given, those skilled in the art will not only understand the general inventive concepts and their attendant advantages, but will also find apparent various changes and modifications to the systems and methods disclosed. For example, although the exemplary embodiments set forth herein are directed to the creation of photo books, the general inventive concepts are just as applicable to other photo products such as cards and calendars. It is sought, therefore, to cover all such changes and modifications as fall within the spirit and scope of the general inventive concepts, as defined by the submission of this document and related papers, and any equivalents thereof.

1. A method of creating an article, the method comprising:
defining a plurality of themes;
defining a plurality of styles;
selecting a desired theme from said plurality of themes;
defining a group of permissible styles based on said desired theme, wherein at least one style from said plurality of styles is included in said group of permissible styles and at least one style from said plurality of styles is not included in said group of permissible styles;
selecting at least one desired style from said group of permissible styles;
inputting a plurality of digital images; and
using said desired theme, said at least one desired style, and said digital images in creating said article.

2. The method of claim 1, wherein said article is a photo book.

3. The method of claim 2, further comprising printing said photo book on a physical medium.

4. The method of claim 1, further comprising:
defining a plurality of layouts;
defining a group of permissible layouts based on said at least one desired style, wherein at least one layout from said plurality of layouts is included in said group of permissible layouts and at least one layout from said plurality of layouts is not included in said group of permissible layouts;
selecting at least one desired layout from said group of permissible layouts; and
using said desired layout in creating said article.

5. The method of claim 4, wherein said article is a photo book.

6. The method of claim 5, further comprising printing said photo book on a physical medium.

7. The method of claim 1, further comprising:
defining a plurality of design elements;
defining a group of permissible design elements based on said desired theme, wherein at least one design element from said plurality of design elements is included in said group of permissible design elements and at least one design element from said plurality of design elements is not included in said group of permissible design elements;
selecting at least one desired design element from said group of permissible design elements; and
using said desired design element in creating said article.

8. The method of claim 7, wherein said article is a photo book.

9. The method of claim 8, further comprising printing said photo book on a physical medium.

10. The method of claim 1, further comprising:
associating a plurality of fonts and a plurality of backgrounds with each of said styles;
defining a plurality of design elements;
selecting a desired design element from said plurality of design elements;
defining a group of permissible fonts based on said desired design element, wherein at least one font from said plurality of fonts is included in said group of permissible fonts and at least one font from said plurality of fonts is not included in said group of permissible fonts;
defining a group of permissible backgrounds based on said desired design element, wherein at least one background from said plurality of backgrounds is included in said group of permissible backgrounds and at least one background from said plurality of backgrounds is not included in said group of permissible fonts;
selecting a desired font from said group of permissible fonts;
selecting a desired background from said group of permissible backgrounds; and
using said desired font and said desired background in creating said article.

11. The method of claim 10, wherein said article is a photo book.

12. The method of claim 11, further comprising printing said photo book on a physical medium.

13. A system for creating an article, the system comprising:
a computer; and
a data store accessible by said computer,
wherein said computer is operable to access said data store and execute machine-readable instructions to:
identify a plurality of themes;
identify a plurality of styles;
prompt a user to select a desired theme from said plurality of themes;
define a group of permissible styles based on said desired theme, wherein at least one style from said plurality of styles is included in said group of permissible styles and at least one style from said plurality of styles is not included in said group of permissible styles;
prompt said user to select at least one desired style from said group of permissible styles;
allow said user to select a plurality of digital images; and
create said article using said desired theme, said at least one desired style, and said digital images.

14. The system of claim 13, wherein said article is a photo book.

15. The system of claim 14, wherein said photo book is printed on a physical medium.

16. The system of claim 13, wherein said computer is operable to access said data store and execute machine-readable instructions to:
define a plurality of layouts;
define a group of permissible layouts based on said at least one desired style, wherein at least one layout from said plurality of layouts is included in said group of permissible layouts and at least one layout from said plurality of layouts is not included in said group of permissible layouts;
prompt said user to select at least one desired layout from said group of permissible layouts; and
create said article using said desired layout.

17. The system of claim 16, wherein said article is a photo book.

18. The system of claim 17, wherein said photo book is printed on a physical medium.

19. The system of claim 13, wherein said computer is operable to access said data store and execute machine-readable instructions to:
define a plurality of design elements;
define a group of permissible design elements based on said desired theme, wherein at least one design element from said plurality of design elements is included in said group of permissible design elements and at least one design element from said plurality of design elements is not included in said group of permissible design elements;
prompt said user to select at least one desired design element from said group of permissible design elements; and
create said article using said desired design element.

20. The system of claim 19, wherein said article is a photo book.

21. The system of claim 20, wherein said photo book is printed on a physical medium.

22. The system of claim 13, wherein said computer is operable to access said data store and execute machine-readable instructions to:
associate a plurality of fonts and a plurality of backgrounds with each of said styles;
define a plurality of design elements;
prompt said user to select a desired design element from said plurality of design elements;
define a group of permissible fonts based on said desired design element, wherein at least one font from said plurality of fonts is included in said group of permissible fonts and at least one font from said plurality of fonts is not included in said group of permissible fonts;
define a group of permissible backgrounds based on said desired design element, wherein at least one background from said plurality of backgrounds is included in said group of permissible backgrounds and at least one background from said plurality of backgrounds is not included in said group of permissible fonts;
prompt said user to select a desired font from said group of permissible fonts;
prompt said user to select a desired background from said group of permissible backgrounds; and
create said article using said desired font and said desired background.

23. The system of claim 22, wherein said article is a photo book.

24. The system of claim 23, wherein said photo book is printed on a physical medium.
